(19) United States
(12) Patent Application Publication
(10) Pub. No.: US 2025/0313148 A1
(43) Pub. Date: Oct. 9, 2025

(54) VEHICLE BRAKE LIGHT DEVICE

(71) Applicant: Noah Frandsen, San Marcos, CA (US)

(72) Inventor: Noah Frandsen, San Marcos, CA (US)

(21) Appl. No.: 18/629,337

(22) Filed: Apr. 8, 2024

(51) Int. Cl. B60Q 1/44; B60Q 1/22; B60Q 1/34; B60Q 1/46

(52) U.S. Cl. CPC B60Q 1/444; B60Q 1/22; B60Q 1/34; B60Q 1/46

(57) ABSTRACT

A vehicle brake light device includes a brake light that is mounted to a rear end of a vehicle. The brake light is turned on when a braking system of the vehicle is engaged thereby facilitating a driver of a following vehicle to be alerted that the vehicle is braking. Additionally, the brake light is progressively illuminated along a length of the brake light in accordance with a degree to which the braking system is being engaged thereby facilitating the driver of the following vehicle to be alerted to the degree to which the vehicle is braking such that the driver of the following vehicle can avoid a rear end collision with the vehicle. Furthermore, the brake light is laterally elongated to extend across a majority of a width of the rear end of the vehicle to enhance the driver of the following vehicle's ability to perceive the brake light.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle brake light devices and more particularly pertains to a new vehicle brake light device for facilitating a driver of a following vehicle to perceive the intensity to which a vehicle is braking. The device includes a brake light that is laterally elongated to extend across a majority of a rear end of a vehicle. The brake light is illuminated from a center of the brake light toward each end of the brake light to a degree which corresponds to the degree to which a braking system of the vehicle is engaged. In this way the brake light facilitates a driver of a following vehicle to visually identify the degree to which the vehicle is braking.

### (2) Description of Related Art Including Information Disclosed Under 37 CFR 1.97 and 1.98

The prior art relates to vehicle brake light devices including a brake light that is mounted to a rear end of a vehicle. The brake light is turned on when a braking system of the vehicle is engaged thereby facilitating a driver of a following vehicle to be alerted that the vehicle is braking. Additionally, the brake light is progressively illuminated along a length of the brake light in accordance with a degree to which the braking system is being engaged thereby facilitating the driver of the following vehicle to be alerted to the degree to which the vehicle is braking such that the driver of the following vehicle can avoid a rear end collision with the vehicle. Furthermore, the brake light is laterally elongated to extend across a majority of a width of the rear end of the vehicle to enhance the driver of the following vehicle's ability to perceive the brake light.

### BRIEF SUMMARY OF THE INVENTION

An embodiment of the disclosure meets the needs presented above by generally comprising a brake light that is mounted to a rear end of a vehicle. The brake light is turned on when a braking system of the vehicle is engaged thereby facilitating a driver of a following vehicle to be alerted that the vehicle is braking. Additionally, the brake light is progressively illuminated along a length of the brake light in accordance with a degree to which the braking system is being engaged. In this way the brake light facilitates the driver of the following vehicle to be alerted to the degree to which the vehicle is braking such that the driver of the following vehicle can avoid a rear end collision with the vehicle. Furthermore, the brake light is laterally elongated such that the brake light extends across a majority of a width of the rear end of the vehicle to enhance the driver of the following vehicle's ability to perceive the brake light.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear view of a vehicle brake light device according to an embodiment of the disclosure.

FIG. 2 is a perspective in-use view of an embodiment of the disclosure showing a percentage to which a brake light is illuminated according to a degree to which a brake pedal is depressed.

FIG. 3 is a perspective in-use view of an embodiment of the disclosure showing a brake light being illuminated along a full length of the brake light according to a brake pedal being fully depressed.

FIG. 4 is a perspective in-use view of an embodiment of the disclosure showing a brake light being dimly illuminated when a brake pedal is not depressed.

FIG. 5 is a perspective in-use view of an embodiment of the disclosure showing a following vehicle traveling on a roadway behind a vehicle.

### DETAILED DESCRIPTION OF THE INVENTION

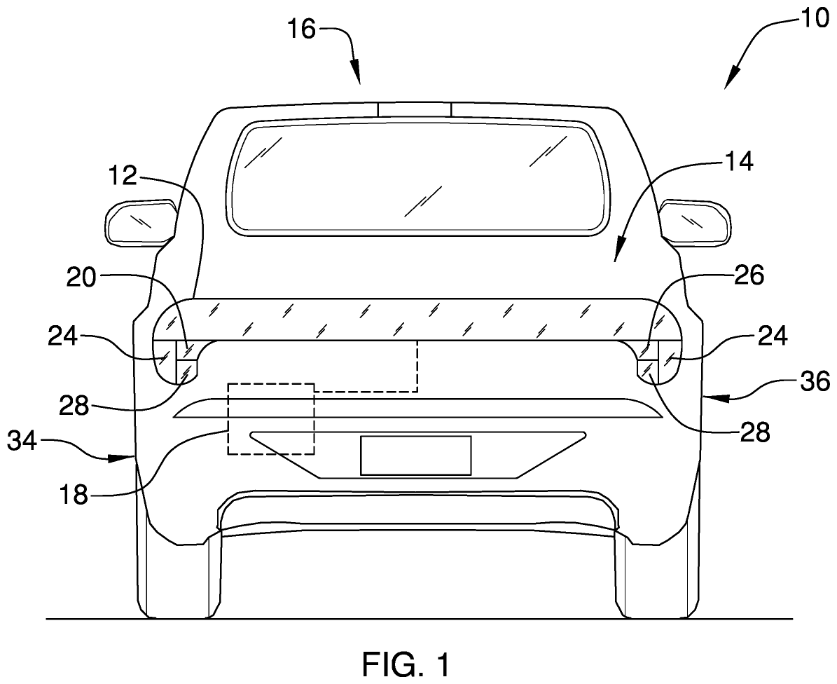

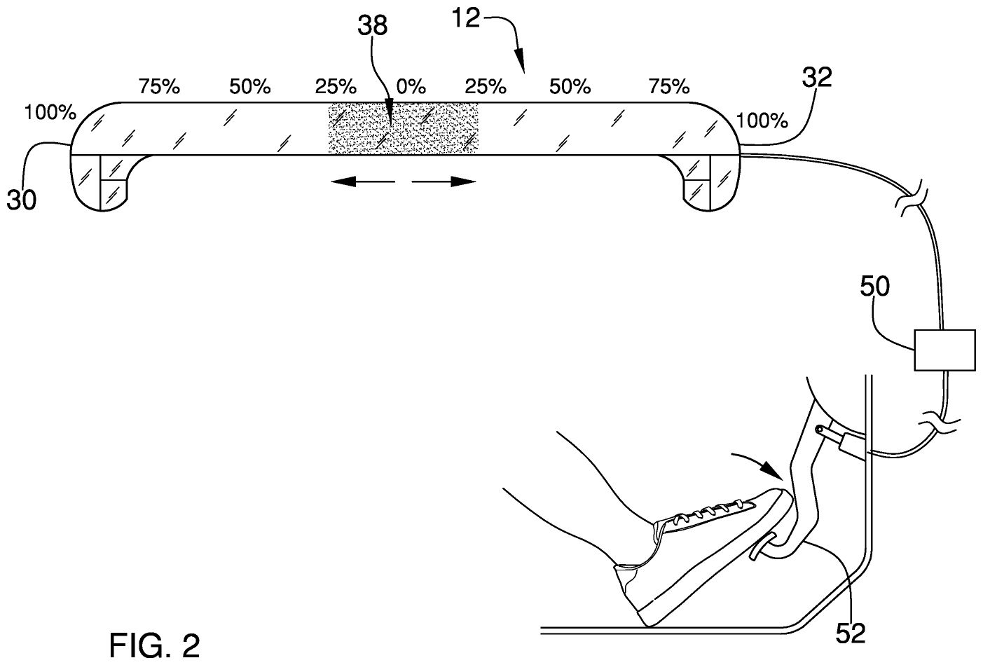

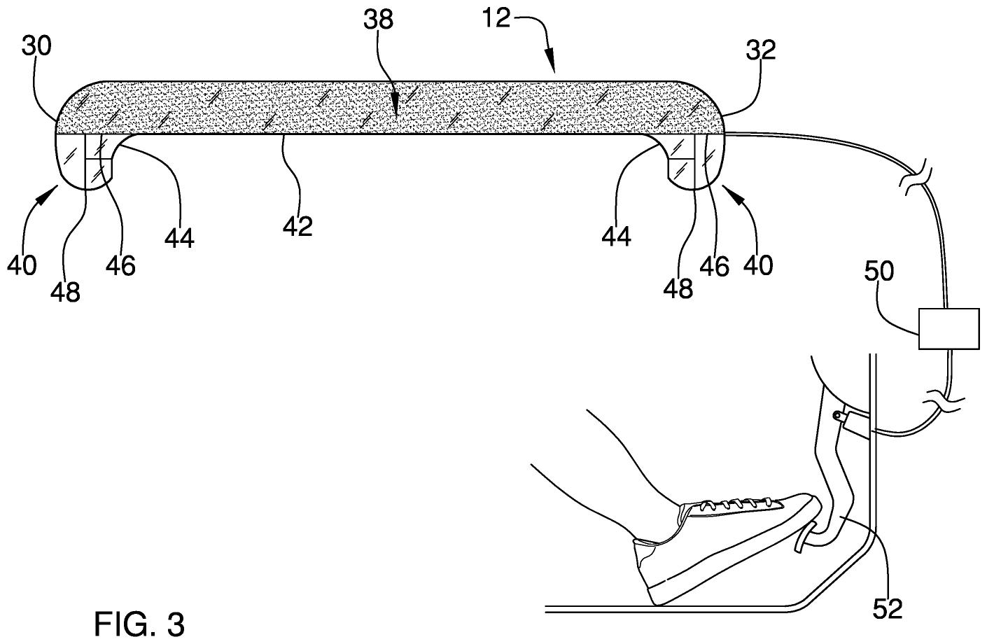

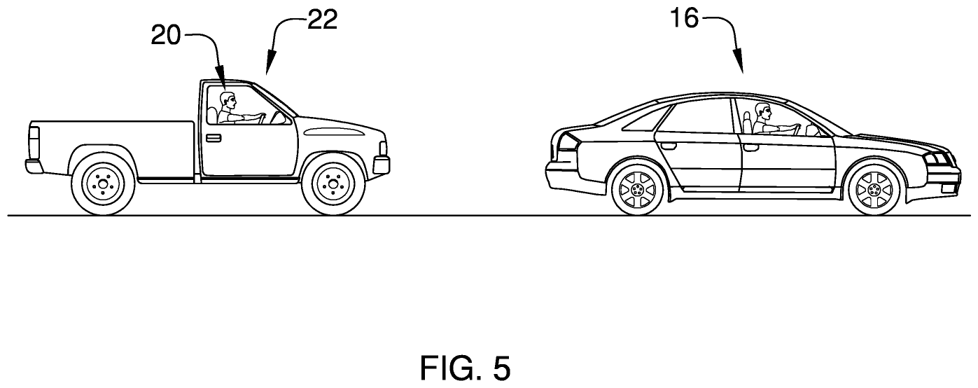

With reference now to the drawings, and in particular to FIGS. 1 through 5 thereof, a new vehicle brake light device embodying the principles and concepts of an embodiment of the disclosure and generally designated by the reference numeral 10 will be described.

As best illustrated in FIGS. 1 through 5, the vehicle brake light device 10 generally comprises a brake light 12 that is mounted to a rear end 14 of a vehicle 16. The vehicle 16 may be a passenger vehicle, a cargo vehicle or any other type of motorized vehicle that is commonly driven on public roadways. The brake light 12 is in communication with a braking system 18 of the vehicle 16 and the brake light 12 is turned on when the braking system 18 is engaged. In this way the brake light 12 emits light outwardly from the rear end 14 of the vehicle 16 thereby facilitating a driver 20 of a following vehicle 22 to be alerted that the vehicle 16 is braking. Furthermore, the brake light 12 is progressively illuminated along a length of the brake light 12 in accordance with a degree to which the braking system 18 is being engaged. In this way the brake light 12 facilitates the driver 20 of the following vehicle 22 to be alerted to the degree to which the vehicle 16 is braking such that the driver 20 of the following vehicle 22 can avoid a rear end collision with the vehicle 16. Additionally, the brake light 12 is laterally elongated such that the brake light 12 extends across a majority of a width of the rear end 14 of the vehicle 16 to enhance the driver 20 of the following vehicle 22 to perceive the brake light 12.

The brake light 12 includes a pair of turn signal lights 24 each located on opposing ends of the brake light 12 from each other. Additionally, the brake light 12 includes a pair of reverse lights 26 each disposed on opposing ends of the brake light 12 from each other. Finally, the brake light 12 includes a pair of emergency lights 28 each disposed on opposing ends of the brake light 12 from each other. The brake light 12 is elongated between a first end 30 and a second end 32 of the brake light 12 such that each of the first end 30 and the second end 32 is located adjacent to a respective one of a driver's side 34 and a passenger's side 36 of the vehicle 16. Additionally, the brake light 12 is illuminated starting from a center 38 of the brake light 12 and progressing toward each of the first end 30 and the second end 32 of the brake light 12 according to the degree to which the braking system 18 is engaged. Furthermore, the brake light 12 is fully illuminated between the first end 30 and the second end 32 when the braking system 18 is engaged to a maximum intensity.

Each of the first end 30 and the second end 32 is rounded to define a pair of lobes 40 each extending downwardly from a bottom edge 42 of the brake light 12. Additionally, each of the pair of lobes 40 has an inwardly facing edge 44 and the inwardly facing edge 44 of each of the pair of lobes 40 curves toward the inwardly facing edge 44 of the opposite lobe 40 and intersects the bottom edge 42. Each of the pair of turn signal lights 24 is positioned on a respective one of the pair of lobes 40 and each of the pair of turn signal lights 24 extends between a lower threshold 46 of the brake light 12 and a lower end 48 of the respective lobe 40. Furthermore, each of the pair of turn signal lights 24 extends from a respective one of the first end 30 and the second end 32 of the brake light 12 toward a center 38 of the respective lobe 40.

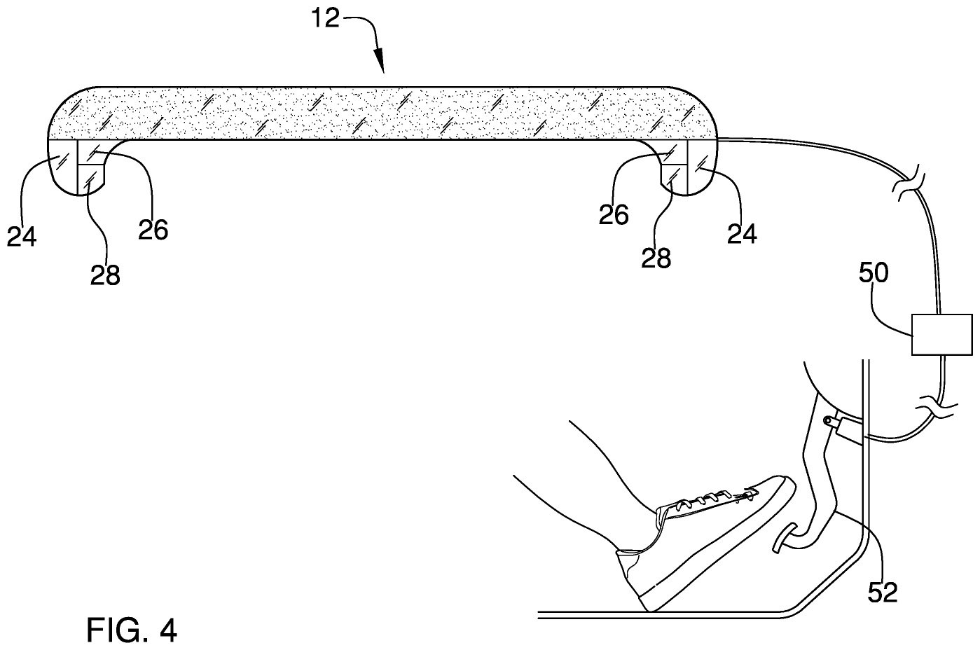

Each of the pair of reverse lights 26 is positioned on a respective one of the pair of lobes 40 and each of the pair of reverse lights 26 extends from the lower threshold 46 of the brake light 12 toward the lower end 48 of the respective lobe 40. Additionally, each of the pair of reverse lights 26 extends between a respective one of the pair of turn signal lights 24 and the inwardly facing edge 44 of the respective lobe 40. Each of the pair of emergency lights 28 is positioned on a respective one of the pair of lobes 40 and each of the pair of emergency lights 28 extends between a respective one of the pair of reverse lights 26 and the lower end 48 of the respective lobe 40. Additionally, each of the pair of emergency lights 28 extends between a respective one of the turn signal lights 24 and the inwardly facing edge 44 of the respective lobe 40. Each of the brake light 12 and the pair of turn signal lights 24 and the pair of reverse lights 26 and the pair of emergency lights 28 may comprise a light emitting diode or other type of electronic light emitter. Furthermore, as is shown in FIG. 4, the brake light 12 may be dimly illuminated between the first end 30 and the second end 32 when the braking system 18 of the vehicle 16 is not engaged.

A control box 50 is positioned within the vehicle 16 and the control box 50 is in electrical communication with the braking system 18 of the vehicle 16 thereby facilitating the control box 50 to determine a degree to which a brake pedal 52 of the vehicle 16 is depressed. Additionally, the control box 50 is in electrical communication with the brake light 12. In this way the control box 50 actuates the brake light 12 to be illuminated between the center 38 of the brake light 12 and each of the first end 30 and the second end 32 of the brake light 12 according to the degree to which the brake pedal 52 is depressed such that the brake light 12 is fully illuminated between the first end 30 and the second end 32 when the brake pedal 52 is fully depressed. The control box 50 may include a processing circuit and a brake pedal position sensing circuit to facilitate the control box 50 to sense the degree to which the brake pedal 52 is depressed as well as to facilitate the brake light 12 to be illuminated to a degree which corresponds to the position of the brake pedal 52.

In use, the brake light 12 is illuminated, starting from the center 38 of the brake light 12 and progressing toward each of the first end 30 and the second end 32 of the brake light 12, when the brake pedal 52 in the vehicle 16 is depressed. As the degree to which the brake pedal 52 is depressed increases, the degree to which the brake light 12 is illuminated between the center 38 of the brake light 12 and each of the first end 30 and the second end 32 increases to visually indicate the degree to which the brake pedal 52 is being depressed. Furthermore, the brake light 12 is fully illuminated between the first end 30 and the second end 32 when the brake pedal 52 is fully depressed. In this way a driver 20 of a following vehicle 22 that is behind the vehicle 16 can be visually alerted to the degree to which the vehicle 16 is braking thereby enhancing the ability of the driver 20 of the following vehicle 22 to avoid a rear end collision with the vehicle 16. Thus, the driver 20 of the following vehicle 22 can continuously maintain a safe distance between the following vehicle 22 and the vehicle 16 even when the braking system 18 of the vehicle 16 has been fully engaged in the event of an emergency braking situation. In this way the driver 20 of the following vehicle 22 can maintain a safe distance while driving in a hilly environment or situations of limited visibility, such as foggy conditions for example.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle brake light device for progressively displaying the degree to which a brake pedal in a vehicle is being depressed thereby facilitating a driver in a following vehicle to interpret the degree to which the vehicle is braking, said device comprising:
a brake light being mounted to a rear end of a vehicle, said brake light being in communication with a braking system of said vehicle, said brake light being turned on when said braking system is engaged wherein said brake light is configured to emit light outwardly from said rear end of said vehicle thereby facilitating a driver of a following vehicle to be alerted that said vehicle is braking, said brake light being progressively illuminated along a length of said brake light in accordance with a degree to which said braking system is being engaged wherein said brake light is configured to facilitate the driver of the following vehicle to be alerted to the degree to which said vehicle is braking such that the driver of the following vehicle can avoid a rear end collision with said vehicle, said brake light being laterally elongated such that said brake light extends across a majority of a width of said rear end of said vehicle wherein said brake light is configured to enhance the driver of the following vehicle's ability to perceive said brake light, said brake light including a pair of turn signal lights each being located on opposing ends of said brake light from each other, said brake light including a pair of reverse lights each being disposed on opposing ends of said brake light from each other, said brake light including a pair of emergency lights each being disposed on opposing ends of said brake light from each other.

2. The device according to claim 1, wherein:
said brake light is elongated between a first end and a second end of said brake light such that each of said first end and said second end is located adjacent to a respective one of a driver's side and a passenger's side of said vehicle;
said brake light is illuminated starting from a center of said brake light and progressing toward each of said first end and said second end of said brake light according to the degree to which said braking system is engaged such that said brake light is fully illuminated between said first end and said second end when said braking system is engaged to a maximum intensity;
each of said first end and said second end is rounded to define a pair of lobes each extending downwardly from a bottom edge of said brake light; and
each of said pair of lobes has an inwardly facing edge, said inwardly facing edge of each of said pair of lobes curving toward said inwardly facing edge of the opposite lobe and intersects said bottom edge.

3. The device according to claim 2, wherein:
each of said pair of turn signal lights is positioned on a respective one of said pair of lobes;
each of said pair of turn signal lights extends between a lower threshold of said brake light and a lower end of said respective lobe; and
each of said pair of turn signal lights extends from a respective one of said first end and said second end of said brake light toward a center of said respective lobe.

4. The device according to claim 3, wherein:
each of said pair of reverse lights is positioned on a respective one of said pair of lobes;
each of said pair of reverse lights extends from said lower threshold of said brake light toward said lower end of said respective lobe; and
each of said pair of reverse lights extends between a respective one of said pair of turn signal lights and said inwardly facing edge of said respective lobe.

5. The device according to claim 4, wherein:
each of said pair of emergency lights is positioned on a respective one of said pair of lobes;
each of said pair of emergency lights extends between a respective one of said pair of reverse lights and said lower end of said respective lobe; and
each of said pair of emergency lights extends between a respective one of said turn signal lights and said inwardly facing edge of said respective lobe.

6. The device according to claim 2, wherein:
said device includes a control box being positioned within said vehicle;
said control box is in electrical communication with said braking system of said vehicle thereby facilitating said control box to determine a degree to which a brake pedal of said vehicle is depressed; and
said control box is in electrical communication with said brake light such that said control box actuates said brake light to be illuminated between said center of said brake light and each of said first end and said second end of said brake light according to the degree to which said brake pedal is depressed such that said brake light is fully illuminated between said first end and said second end when said brake pedal is fully depressed.

7. A vehicle brake light device for progressively displaying the degree to which a brake pedal in a vehicle is being depressed thereby facilitating a driver in a following vehicle to interpret the degree to which the vehicle is braking, said device comprising:
a brake light being mounted to a rear end of a vehicle, said brake light being in communication with a braking system of said vehicle, said brake light being turned on when said braking system is engaged wherein said brake light is configured to emit light outwardly from said rear end of said vehicle thereby facilitating a driver of a following vehicle to be alerted that said vehicle is braking, said brake light being progressively illuminated along a length of said brake light in accordance with a degree to which said braking system is being engaged wherein said brake light is configured to facilitate the driver of the following vehicle to be alerted to the degree to which said vehicle is braking such that the driver of the following vehicle can avoid a rear end collision with said vehicle, said brake light being laterally elongated such that said brake light extends across a majority of a width of said rear end of said vehicle wherein said brake light is configured to enhance the driver of the following vehicle's ability to perceive said brake light, said brake light including a pair of turn signal lights each being located on opposing ends of said brake light from each other, said brake light including a pair of reverse lights each being disposed on opposing ends of said brake light from each other, said brake light including a pair of emergency lights each being disposed on opposing ends of said brake light from each other, said brake light being elongated between a first end and a second end of said brake light such that each of said first end and said second end is located adjacent to a respective one of a driver's side and a passenger's side of said vehicle, said brake light being illuminated starting from a center of said brake light and progressing toward each of said first end and said second end of said brake light according to the degree to which said braking system is engaged such that said brake light is fully illuminated between said first end and said second end when said braking system is engaged to a maximum intensity, each of said first end and said second end being rounded to define a pair of lobes each extending downwardly from a bottom edge of said brake light, each of said pair of lobes has an inwardly facing edge, said inwardly facing edge of each of said pair of lobes curving toward said inwardly facing edge of the opposite lobe and intersects said bottom edge, each of said pair of turn signal lights being positioned on a respective one of said pair of lobes, each of said pair of turn signal lights extending between a lower threshold of said brake light and a lower end of said respective lobe, each of said pair of turn signal lights extending from a respective one of said first end and said second end of said brake light toward a center of said respective lobe, each of said pair of reverse lights being positioned on a respective one of said pair of lobes, each of said pair of reverse lights extending from said lower threshold of said brake light toward said lower end of said respective lobe, each of said pair of reverse lights extending between a respective one of said pair of turn signal lights and said inwardly facing edge of said respective lobe, each of said pair of emergency lights being positioned on a respective one of said pair of lobes, each of said pair of emergency lights extending between a respective one of said pair of reverse lights and said lower end of said respective lobe, each of said pair of emergency lights extending between a respective one of said turn signal lights and said inwardly facing edge of said respective lobe; and
a control box being positioned within said vehicle, said control box being in electrical communication with said braking system of said vehicle thereby facilitating said control box to determine a degree to which a brake pedal of said vehicle is depressed, said control box being in electrical communication with said brake light such that said control box actuates said brake light to be illuminated between said center of said brake light and each of said first end and said second end of said brake light according to the degree to which said brake pedal is depressed such that said brake light is fully illuminated between said first end and said second end when said brake pedal is fully depressed.

8. A vehicle brake light system for progressively displaying the degree to which a brake pedal in a vehicle is being depressed thereby facilitating a driver in a following vehicle to interpret the degree to which the vehicle is braking, said device comprising:
a vehicle having a rear end and a driver's side and a passenger's side, said vehicle including a braking system, said braking system including a brake pedal;
a brake like being mounted to said rear end of said vehicle, said brake light being in communication with said braking system of said vehicle, said brake light being turned on when said braking system is engaged wherein said brake light is configured to emit light outwardly from said rear end of said vehicle thereby facilitating a driver of a following vehicle to be alerted that said vehicle is braking, said brake light being progressively illuminated along a length of said brake light in accordance with a degree to which said braking system is being engaged wherein said brake light is configured to facilitate the driver of the following vehicle to be alerted to the degree to which said vehicle is braking such that the driver of the following vehicle can avoid a rear end collision with said vehicle, said brake light being laterally elongated such that said brake light extends across a majority of a width of said rear end of said vehicle wherein said brake light is configured to enhance the driver of the following vehicle to perceive said brake light, said brake light including a pair of turn signal lights each being located on opposing ends of said brake light from each other, said brake light including a pair of reverse lights each being disposed on opposing ends of said brake light from each other, said brake light including a pair of emergency lights each being disposed on opposing ends of said brake light from each other, said brake light being elongated between a first end and a second end of said brake light such that each of said first end and said second end is located adjacent to a respective one of a driver's side and a passenger's side of said vehicle, said brake light being illuminated starting from a center of said brake light and progressing toward each of said first end and said second end of said brake light according to the degree to which said braking system is engaged such that said brake light is fully illuminated between said first end and said second end when said braking system is engaged to a maximum intensity, each of said first end and said second end being rounded to define a pair of lobes each extending downwardly from a bottom edge of said brake light, each of said pair of lobes has an inwardly facing edge, said inwardly facing edge of each of said pair of lobes curving toward said inwardly facing edge of the opposite lobe and intersects said bottom edge, each of said pair of turn signal lights being positioned on a respective one of said pair of lobes, each of said pair of turn signal lights extending between a lower threshold of said brake light and a lower end of said respective lobe, each of said pair of turn signal lights extending from a respective one of said first end and said second end of said brake light toward a center of said respective lobe, each of said pair of reverse lights being positioned on a respective one of said pair of lobes, each of said pair of reverse lights extending from said lower threshold of said brake light toward said lower end of said respective lobe, each of said pair of reverse lights extending between a respective one of said pair of turn signal lights and said inwardly facing edge of said respective lobe, each of said pair of emergency lights being positioned on a respective one of said pair of lobes, each of said pair of emergency lights extending between a respective one of said pair of reverse lights and said lower end of said respective lobe, each of said pair of emergency lights extending between a respective one of said turn signal lights and said inwardly facing edge of said respective lobe; and
a control box being positioned within said vehicle, said control box being in electrical communication with said braking system of said vehicle thereby facilitating said control box to determine a degree to which said brake pedal of said vehicle is depressed, said control box being in electrical communication with said brake light such that said control box actuates said brake light to be illuminated between said center of said brake light and each of said first end and said second end of said brake light according to the degree to which said brake pedal is depressed such that said brake light is fully illuminated between said first end and said second end when said brake pedal is fully depressed.
